(19) United States
(12) Patent Application Publication
(10) Pub. No.: US 2019/0310697 A1
(43) Pub. Date: Oct. 10, 2019

(54) POWER SUPPLY UNIT

(71) Applicant: Microsoft Technology Licensing, LLC, Redmond, WA (US)

(72) Inventors: Shaun L. Harris, Burton, TX (US); William R. Harris, Redmond, WA (US); John J. Siegler, Carnation, WA (US); Banha Sok, Kirkland, WA (US)

(73) Assignee: Microsoft Technology Licensing, LLC, Redmond, WA (US)

(21) Appl. No.: 15/949,636

(22) Filed: Apr. 10, 2018

(51) Int. Cl. G06F 1/26; H02M 1/42; H02M 7/217

(52) U.S. Cl. CPC G06F 1/263; H02M 3/156; H02M 7/2173; H02M 1/4208

(57) ABSTRACT

A power supply unit includes a set of primary circuits operably coupled to a set of phase pair electrical inputs. The electrical inputs provide an input voltage via alternating current. Each primary circuit receives a phased pair electrical input of the set of phase pair electrical inputs and provides a tap output. A single transformer is operably coupled to each tap output. A single secondary circuit is operably coupled to the transformer to provide an output voltage via a direct current.

### BACKGROUND

A power supply is an electrical device that provides electric power to an electrical load. A task of a power supply is to convert an input electrical signal, often including a given voltage, current, and frequency, from a source to a selected signal having a selected voltage, current, and frequency to power the load. Power supplies may include addition features to perform tasks including limiting the current drawn by the load to safe levels, shutting off the current in the event of an electrical fault, power conditioning to prevent electronic noise or voltage surges on the input from reaching the load, power-factor correction, and storing energy so it can continue to power the load in the event of a temporary interruption in the source power. A power supply unit for a computing device, such as a server or desktop, can convert a mains or relatively high voltage alternating current into a regulated direct current power, often at a relatively lower voltage, to the processor and other peripherals or circuits of the computing device. In general, the relatively high voltage source may come from a wall outlet connected to the power grid or solar power converter, from generators or alternators, power distribution units, such as power distribution management units in a datacenter, or other power supplies. In some examples, the power supply unit may provide more than one selected voltage of direct current power.

### SUMMARY

This summary is provided to introduce a selection of concepts in a simplified form that are further described below in the Description. This summary is not intended to identify key features or essential features of the claimed subject matter, nor is it intended to be used to limit the scope of the claimed subject matter.

A power supply unit includes a plurality of primary circuits operably coupled to a plurality of phase pair electrical inputs. For example, the power supply can include three primary circuits configured to with the same or similar electrical components. Each of the primary circuits can include a non-isolated power factor correction circuit and a bulk energy storage circuit. The electrical inputs provide an input voltage via alternating current. Each primary circuit receives a phased pair electrical input of the plurality of phase pair electrical inputs and provides a tap output to the transformer. For example, a first primary circuit receives a first phase pair electrical input, a second primary circuit receives a second phase pair electrical input, and a third primary circuit receives a third phase pair electrical input. A single transformer is operably coupled to each tap output from the non-isolated transformer pair. A single secondary circuit is operably coupled to the transformer to provide an output voltage via a direct current. A switching circuit is operably coupled from the secondary circuit to the plurality of primary circuits synchronously or asynchronously.

### BRIEF DESCRIPTION OF THE DRAWINGS

The accompanying drawings are included to provide a further understanding of embodiments and are incorporated in and constitute a part of this disclosure. The drawings illustrate embodiments and together with the description serve to explain principles of embodiments. Other embodiments and many of the intended advantages of embodiments will be readily appreciated, as they become better understood by reference to the following description. The elements of the drawings are not necessarily to scale relative to each other. Like reference numerals designate corresponding similar parts.

FIG. 1 is a block diagram illustrating an example of a computing device, which in some instances can be configured as a computer network in a datacenter to provide, for example, a cloud-computing environment.

FIG. 2 is a schematic diagram illustrating an example power system in a datacenter.

FIG. 3 is a block diagram illustrating an example power supply unit of the power system of FIG. 2.

FIG. 4 is a schematic diagram illustrating an example of the power supply unit of FIG. 3.

### DESCRIPTION

In the following Description, reference is made to the accompanying drawings, which form a part hereof, and in which is shown by way of illustration specific embodiments in which the invention may be practiced. It is to be understood that other embodiments may be utilized and structural or logical changes may be made without departing from the scope of the present invention. The following description, therefore, is not to be taken in a limiting sense. It is to be understood that features of the various example embodiments described herein may be combined, in part or whole, with each other, unless specifically noted otherwise.

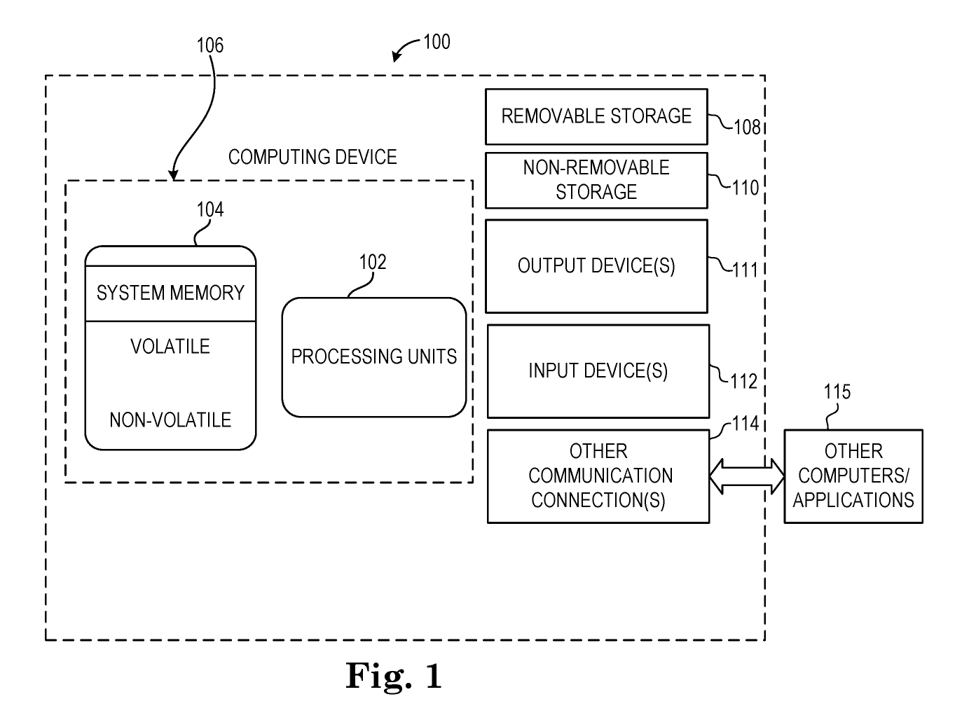

FIG. 1 illustrates an exemplary computer system that can be employed in an operating environment and used to host or run a computer application included on one or more computer readable storage mediums storing computer executable instructions for controlling the computer system, such as a computing device, to perform a process.

The exemplary computer system includes a computing device, such as computing device 100. The computing device 100 can take one or more of several forms. Such forms include a tablet, a personal computer, a workstation, a server, such as a rack mounted server will associated components, a handheld device, a consumer electronic device (such as a video game console or a digital video recorder), or other, and can be a stand-alone device or configured as part of a computer network.

In a basic hardware configuration, computing device 100 typically includes a processor system having one or more processing units, i.e., processors 102, and memory 104. By way of example, the processing units may include two or more processing cores on a chip or two or more processor chips. In some examples, the computing device can also have one or more additional processing or specialized processors (not shown), such as a graphics processor for general-purpose computing on graphics processor units, to perform processing functions offloaded from the processor 102. The memory 104 may be arranged in a hierarchy and may include one or more levels of cache. Depending on the configuration and type of computing device, memory 104 may be volatile (such as random access memory (RAM)), non-volatile (such as read only memory (ROM), flash memory, etc.), or some combination of the two.

Computing device 100 can also have additional features or functionality. For example, computing device 100 may also include additional storage. Such storage may be removable or non-removable and can include magnetic or optical disks, solid-state memory, or flash storage devices such as removable storage 108 and non-removable storage 110. Computer storage media includes volatile and nonvolatile, removable and non-removable media implemented in any suitable method or technology for storage of information such as computer readable instructions, data structures, program modules or other data. Memory 104, removable storage 108 and non-removable storage 110 are all examples of computer storage media. Computer storage media includes RAM, ROM, EEPROM, flash memory or other memory technology, CD-ROM, digital versatile discs (DVD) or other optical storage, magnetic cassettes, magnetic tape, magnetic disk storage or other magnetic storage devices, universal serial bus (USB) flash drive, flash memory card, or other flash storage devices, or any other storage medium that can be used to store the desired information and that can be accessed by computing device 100. Accordingly, a propagating signal by itself does not qualify as storage media. Any such computer storage media may be part of computing device 100.

Computing device 100 often includes one or more input and/or output connections, such as USB connections, display ports, proprietary connections, and others to connect to various devices to provide inputs and outputs to the computing device. The computing device 100 may include, or be operably couplable to, input devices 112 that may include devices such as keyboard, pointing device (e.g., mouse, track pad), stylus, voice input device, touch input device (e.g., touchscreen). The computing device 100 may include, or be operably couplable to, output devices 111 may include devices such as a display, speakers, and printers.

Computing device 100 often includes one or more communication connections 114 that allow computing device 100 to communicate with other computers/applications 115. Example communication connections can include an Ethernet interface, a wireless interface, a bus interface, a storage area network interface, and a proprietary interface. The communication connections can be used to couple the computing device 100 to a computer network, which can be classified according to a wide variety of characteristics such as topology, connection method, and scale. A network is a collection of computing devices and possibly other devices interconnected by communications channels that facilitate communications and allows sharing of resources and information among interconnected devices. Examples of computer networks include a local area network, a wide area network, the Internet, or other network.

In one example, a one or more of computing devices 100 can be configured as servers in a datacenter to provide distributed computing services such as cloud computing services. A rack-mounted server in the datacenter can include one but typically more than one server blades in which each server blade can include a computing device having a set of processors 102 and memory 104 along with additional storage and communication or networking capabilities and a power supply unit. The rack may include a support structure such as a cabinet configured to include several server blades operably coupled to a data-networking switch, a server management switch, and additional data storage devices. The cabinet may also include a rack management card and power distribution unit, such a three-phase power unit. The datacenter may include multiple cabinets with networked computing devices 100, additional storage, network management devices, and power systems.

A datacenter, or data center, can provide pooled resources on which customers or tenants can dynamically provision and scale applications as needed without having to add servers or additional networking. The datacenter can be configured to communicate with local computing devices such used by cloud consumers including personal computers, mobile devices, embedded systems, or other computing devices. Within the data center, computing device 100 can be configured as servers, either as stand alone devices or individual blades in a rack of one or more other server devices. One or more host processors, such as processors 102, as well as other components including memory 104 and storage 110, on each server run a host operating system that can support multiple virtual machines. A tenant may initially use one virtual machine on a server to run an application. The datacenter may activate additional virtual machines on a server or other servers when demand increases, and the datacenter may deactivate virtual machines as demand drops.

Datacenter may be an on-premises, private system that provides services to a single enterprise user or may be a publicly (or semi-publicly) accessible, distributed system that provides services to multiple, possibly unrelated customers and tenants, or may be a combination of both. Further, a datacenter may be a contained within a single geographic location or may be distributed to multiple locations across the globe and provide redundancy and disaster recovery capabilities. For example, the datacenter may designate one virtual machine on a server as the primary location for a tenant's application and may activate another virtual machine on the same or another server as the secondary or back-up in case the first virtual machine or server fails.

Cloud computing is a model of service delivery for enabling convenient, on-demand network access to a shared pool of configurable computing resources that can be rapidly generated and released with nominal management effort or interaction with a provider of the service. Cloud computing allows a cloud consumer to obtain computing resources, such as networks, network bandwidth, servers, processing memory, storage, applications, virtual machines, and services as a service on an elastic and sometimes impermanent basis. Cloud computing platforms and infrastructures allow developers to build, deploy, and manage and resources for applications.

A cloud-computing environment is generally implemented in one or more recognized models to run in one or more network-connected datacenters. A private cloud deployment model includes an infrastructure operated solely for an organization whether it is managed internally or by a third-party and whether it is hosted on premises of the organization or some remote off-premises location. An example of a private cloud includes a self-run datacenter. A public cloud deployment model includes an infrastructure made available to the general public or a large section of the public such as an industry group and run by an organization offering cloud services. A community cloud is shared by several organizations and supports a particular community of organizations with common concerns such as jurisdiction, compliance, or security. Deployment models generally include similar cloud architectures, but may include specific features addressing specific considerations such as security in shared cloud models.

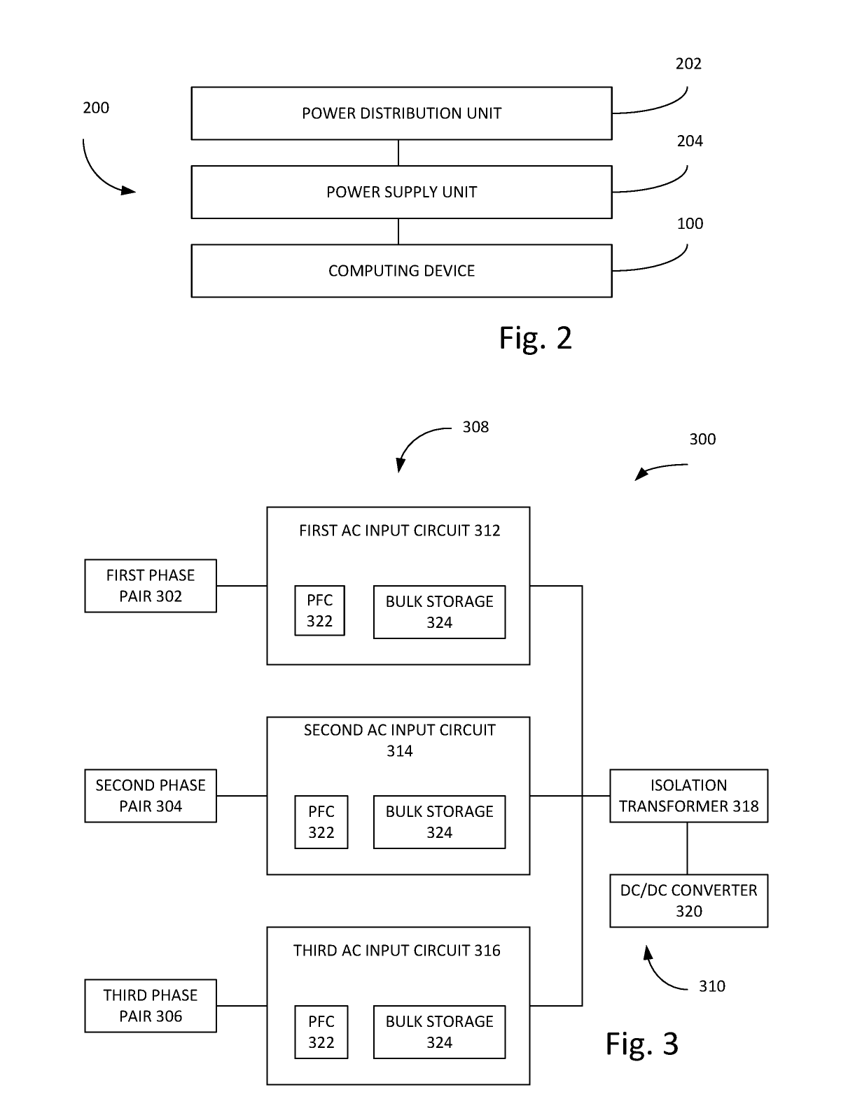

FIG. 2 illustrates an example power system 200 for the computing device 100. The power system 200 includes a power distribution unit 202, which can receive electrical power from a source such as the electrical power grid, an uninterruptable power supply, a generator, or solar power. In some examples, the power distribution unit 202 includes a power distribution management unit. The power distribution unit 202 provides an electrical signal, such as a phased, relatively higher voltage alternating current signal to a power supply unit 204. The power supply unit 204 converts the phased, alternating current signal to one or more relatively direct current signals to power the computing device 100 in one or more modes of operation. In one example, the alternating current signal has a relatively higher voltage amount or magnitude than the direct current voltage amount.

A power distribution unit 202 or power distribution management unit includes a device fitted with multiple outputs designed to distribute electric power, such as to racks of computers and networking equipment located within a datacenter. Datacenters face challenges in power protection and management solutions, and many datacenters rely on power distribution unit monitoring to improve efficiency, uptime, and growth. Power distribution units vary from simple and inexpensive rack-mounted power strips to larger floor-mounted power distribution units with multiple functions including power filtering to improve power quality, intelligent load balancing, and remote monitoring and control by local area networks or simple network management protocol. An example power distribution unit 202 offers intelligent capabilities such as power metering at the inlet, outlet, and power distribution unit branch circuit level and support for environment sensors. In many larger datacenters, larger power distribution units are used to power multiple server cabinets. Each server cabinet or rows of cabinets may require multiple high current circuits possibly from different phases of incoming power or different uninterrupted power supplies. Standalone cabinet power distribution units are self-contained units that include main breakers, individual circuit breakers, and power monitoring panels. The cabinet provides internal bus bars for neutral and grounding. Additionally, intelligent power distribution units allow for IP consolidation, which means many power distribution units can be linked in an array under a single IP address. Power distribution units can also offer integration with electronic locks, providing the ability to network and manage power distribution units and locks through the same appliance.

The power distribution unit 202 can provide three, single phased pairs of outputs to the power supply unit 204. For example, a source power can provide a 200-240 VAC (voltage in alternating current) in three single phase form to the power distribution unit 202 of a rack or cabinet such as via a seven wire connection. The power distribution unit 202 can output six pairs (three pairs per cord) of single phase VAC to each subassembly. In one example, a power supply unit 204 applies 20 mS (milliseconds) of ridethrough capacity because it may be unknown as to which phase is coupled from the power distribution unit 202. In one instance, however, a phase will return within about 12 mS while the other two will return in 20 mS. One example of a power distribution management unit is available under the trade designation Project Olympus E200 PDMU, from Microsoft Corporation of Redmond, Wash.

The power supply unit 204 receives three pairs of phased inputs from the power distribution unit. In one example, three pairs of phased inputs includes two inputs of phase pair A, two inputs of phase pair B, and two inputs of phase pair C. An example magnitude of voltage for each phase pair can be 90 VAC to 240 VAC, although other example voltage amounts are contemplated. The input to the power supply unit 204 can be of unknown generation source, and each phase pair might provide a phase-to-phase voltage or a phase-to-neutral voltage. In one implementation, the power distribution unit 202 can provide three single phases per power cord to the power supply unit 204. In one example, the voltage output from the power supply unit 204 can be in the range of 1.0 to 54 VDC such as 12 VDC (voltage in direct current). In other example, the output voltage from the power supply unit 204 can range from about 1 VDC to 600 VDC depending on the application presented by the receiving system, such as computing device 100. Many computing devices and other systems apply a 12 VDC. Some example telecommunication implementations of the power supply unit 204 can provide a 48 VDC distribution. Other typical configurations of the power supply unit 204 can provide output voltages of 100 VDC, 240 VDC, 380 VDC and 600 VDC.

Various combinations of the computing device 100, power supply unit 204, and power distribution unit 202 of the system can be coupled together in a single device or subsystem. In one example, the computing device 100 and power supply unit 204 can be coupled together in a single apparatus within a cover to form a single system or subsystem. For instance, a server blade or other system can include computing device 100 having a processor 102 and memory 104 along with a power supply 204. In another example, the power distribution unit 202 and power supply unit 204 can be coupled together in a single apparatus within a cover to form a single system or subsystem.

FIG. 3 illustrates an example topology 300 of the example power supply unit 204, which is configured as a switched-mode power supply (as opposed to a linear power supply). In the example, the topology 300 receives three pairs of phased inputs including two inputs of a first phase pair 302, two inputs of a second phase pair 304, and two inputs of a third phase pair 306. The topology 300 includes a primary side 308, or input side, coupled to a secondary side 310, or output side, via a single transformer 318 and associated switching circuitry. The primary side includes multiple AC input circuits, such as AC input circuits 312, 314, 316, that receive phased AC signal pairs, such as first, second, and third phase pairs 302, 304, 306, from the power distribution unit 202.

In the example, a first phase pair 302 is provided to a first AC input circuit 312, a second phase pair 304 is provided to a second AC input circuit 314, and third phase pair 306 is provided to a third AC input circuit 316. Each of the AC input circuit 312, 314, 316, can include a non-isolated power factor power factor correction circuit 322 and a bulk energy storage circuit 324. Non-isolated power factor power factor correction (PFC) circuit 322 in the example reduces the amount of reactive power generated with the topology 300. Power factors, i.e., the ratio of true power (which could be measured in kwatts) divided by the reactive power (in kvar) can be above 0.8 and more typically are selected to provide power factors of 0.95-0.99. Bulk energy storage circuit 324, or bulk capacitor circuits, are used to prevent the output from dropping too far when current is not available.

In one example, the input from the power distribution unit 202 includes three phases, i.e., phase A, phase B, and phase C. In the topology, the first, second, and third phase pairs 302, 304, 306, can be a combination of different phases A, B, C. For example, the first phase pair 302 may include an input from phase A and phase B; the second phase pair 304 may include an input from phase B and phase C, and the third phase pair 306 may include an input from phase C and phase A.

In the topology 300, the multiple AC input circuits 312, 314, 316 provide an output to a single transformer 318 such as an isolation transformer, which is coupled to a single DC/DC converter 320 as the secondary side 310 to provide the output to the computing device 100. The DC/DC converter 320 can include switching circuitry in a feedback loop with the primary side 308.

Instead of multiple independent isolation transformers, or one isolation transformer associated with each of the AC input circuits 312, 314, 316, the topology has the three AC input circuits 312, 314, 316 bundled into to one isolation transformer 318. The amount of energy coupled into the DC/DC converter will be the same as with multiple transformers, but the topology includes one DC/DC converter. The output voltage of the DC/DC converter is provided via a control loop to control switching of the AC input circuits 312, 314, 316 and DC/DC converter duty cycles. Output switching pulses maybe synchronous or asynchronous across the three input phase pair. For example, the primary circuits maybe controlled synchronous or asynchronous across the three primary input phase pair. In this case the primary switch duty is provided from a single DC/DC stage and all primary switching can be synchronous and controlled by an output stage pulse width modulator. Additionally this topology 300 has the advantage of at least one stage returning to working voltage before the other two. This allows the DC/DC output stage to continue operation on a single phase for the brief period until the other phases return.

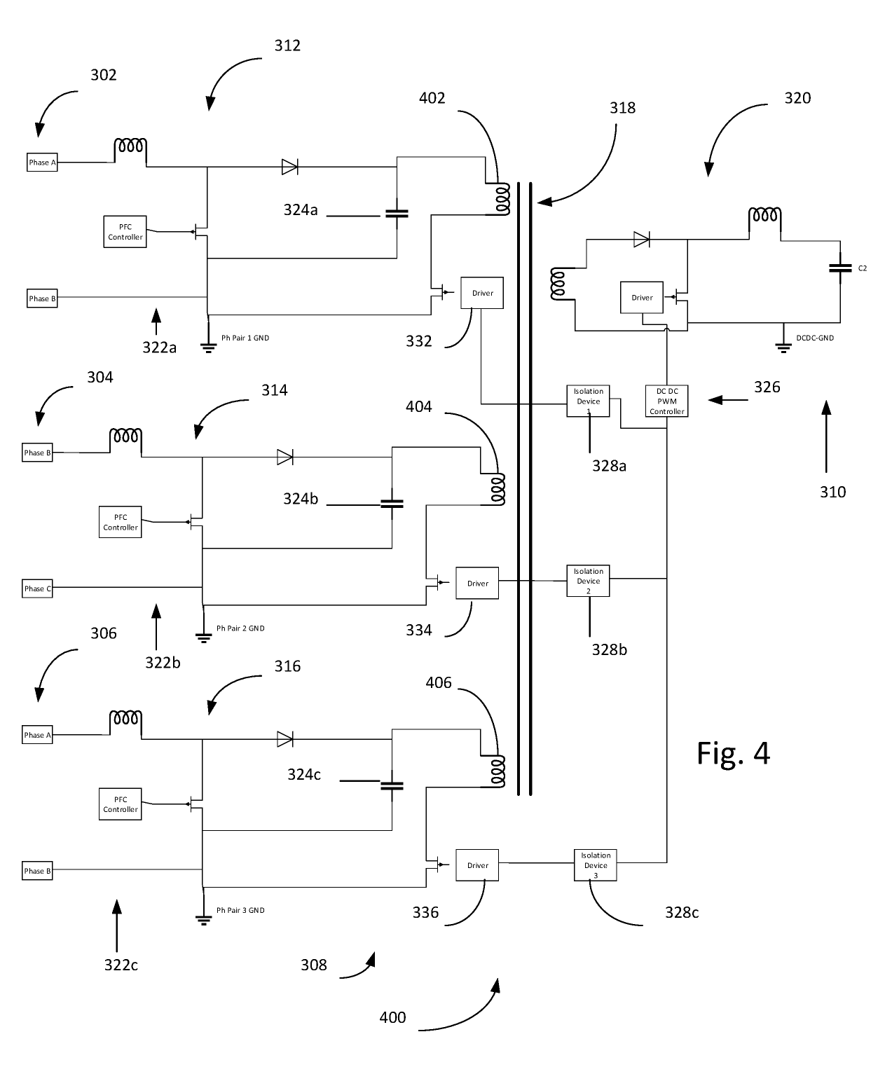

FIG. 4 illustrates a schematic example power supply unit circuit 400 of the topology 300. The power supply unit circuit 400 includes three AC input circuits 312, 314, 316, receiving the first, second, and third phase pair inputs 302, 304, 306, respectively. In the example, the power distribution unit provides two inputs each from a phase A, phase B, and phase C. In the example power supply unit circuit 400, the first, second, and third phase pairs 302, 304, 306, are a combination of different phases A, B, C. In the example, the first phase pair 302 includes an input from phase A and phase B, the second phase pair 304 includes an input from phase B and phase C, and the third phase pair 306 includes an input from phase C and phase A. As indicated, each of the AC input circuits include a PFC circuit 322 and a bulk energy storage circuit 324 as part of a switched-mode power supply. The first AC input circuit includes a PFC circuit 322a, or PFC controller, a bulk energy storage circuit 324a including capacitor C1, and an output tap 402 to the single isolation transformer 318, the second AC input circuit includes a PFC circuit 322b, or PFC controller, a bulk energy storage circuit 324b including capacitor C2, and an output tap 404 to the single isolation transformer 318, and the third AC input includes a PFC circuit 322c, or PFC controller, a bulk energy storage circuit 324c including capacitor C3, and an output tap 406 to the single isolation transformer. In one example, C1, C2, and C3 have generally the same values of capacitance. In one example, the first AC input circuit 312, the second AC input circuit 314, and the third AC input circuit 316 are generally the same and include generally the same values for the electrical components and circuits as each other.

The three taps 402, 404, 406, are provided to a single DC/DC circuit 420, which provides the selected output voltage via direct current to the computing device 100. Switching is provided via a driver coupled to the DC/DC circuit 320 through a pulse width modulator 326 coupled to an isolation circuit 328a, 328b, 328c, and to driver 332 in the first AC input circuit 312, driver 334 in the second AC input circuit 314, and driver 336 in the third AC input circuit 316.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein.

What is claimed is:

1. A power supply unit, comprising:
a plurality of primary circuits operably coupled to a plurality of phase pair electrical inputs providing an input voltage via alternating current, each primary circuit to receive a phase pair electrical input of the plurality of phase pair electrical inputs and provide a tap output;
a single transformer operably coupled to each tap output; and
a single secondary circuit operably coupled to the transformer to provide an output voltage via a direct current.

2. The power supply unit of claim 1 wherein each primary circuit includes a non-isolated power factor conversion circuit.

3. The power supply unit of claim 2 wherein the power factor conversion circuit includes a power factor conversion greater than 0.9.

4. The power supply unit of claim 2 wherein each primary circuit includes a bulk energy storage circuit.

5. The power supply unit of claim 4 wherein each bulk energy storage circuit includes a capacitor.

6. The power supply unit of claim 1 comprising:
a switching circuit.

7. The power supply unit of claim 6 wherein the switching circuit includes a power width modulator operably coupled to each of the plurality of primary circuits.

8. The power supply unit of claim 1 wherein the plurality of primary circuits is three primary circuits.

9. The power supply unit of claim 1 wherein the plurality of phase pair electrical inputs is three phase pair electrical inputs.

10. The power supply of claim 1 wherein the input voltage is 90-240 VAC VAC and the output voltage is 1.0 to 54 VDC.

11. A power supply, comprising:
a first input circuit having a first non-isolated power factor correction circuit and a first bulk energy storage circuit, the first input circuit operably coupled to a first phase pair electrical input of a plurality of phase pair electrical inputs, the first phase pair electrical input to provide an input voltage via alternating current;
a second input circuit having a second non-isolated power factor correction circuit and a second bulk energy storage circuit, the second input circuit operably coupled to a second phase pair electrical input of a plurality of phase pair electrical inputs, the second phase pair electrical input to provide an input voltage via alternating current;
a third input circuit having a third non-isolated power factor correction circuit and a third bulk energy storage circuit, the third input circuit operably coupled to a third phase pair electrical input of a plurality of phase pair electrical inputs, the third phase pair electrical input to provide an input voltage via alternating current;
a single transformer operably coupled to the first input circuit, the second input circuit, and the third input circuit; and
a single secondary circuit operably coupled to the transformer to provide an output voltage via direct current, the secondary circuit including a switching circuit operably coupled to the first input circuit, the second input circuit, and the third input circuit.

12. The power supply of claim 11 wherein the first, second, and third bulk energy storage circuit each includes a bulk capacitor.

13. The power supply of claim 12 wherein each of the first, second, and third input circuits have generally the same electrical components.

14. The power supply of claim 11 wherein the switching circuit includes a pulse width modulator operably coupled to the first, second, and third input circuits.

15. The power supply of claim 11 wherein the input voltage is provided via a electrical signal having three phases, and each phase of the three phases includes two components, wherein the first phase pair includes a component from a first phase and a second phase, the second phase pair includes a component from the second phase and a third phase, and the third phase pair includes a component from the first phase and the third phase.

16. A system, comprising:
a computing device including a processor and a memory, the computing device coupled to a voltage via direct current; and
a power supply operably coupled to the computing device, the power supply comprising:
an plurality of primary circuits operably coupled to a plurality of phase pair electrical inputs providing an input voltage via alternating current, each primary circuit receiving a phased pair electrical input of the plurality of phase pair electrical inputs and providing a tap output;
a single transformer operably coupled to each tap output; and
a single secondary circuit operably coupled to the transformer to provide an output voltage via a direct current to the computing device.

17. The system of claim 16 comprising:
a power distribution unit operably coupled to the power supply unit, the power distribution unit to provide the plurality of phase pair electrical inputs providing an input voltage via alternating current to the plurality of primary circuits.

18. The system of claim 16 wherein the computing device includes a server.

19. The system of claim 16 wherein the secondary circuit includes a switching circuit having a pulse width modulator operably coupled to the plurality of primary circuits.

20. The system of claim 19 wherein the plurality of primary circuits each include a power factor correction circuit and a bulk energy storage circuit.
